(19) United States
(12) Patent Application Publication
(10) Pub. No.: US 2006/0190238 A1
(43) Pub. Date: Aug. 24, 2006

(54) Methods and systems for managing a device

(76) Inventors: Jeffrey S. Autor, Houston, TX (US); Christopher J. Frantz, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/065,997

(22) Filed: Feb. 24, 2005

(51) Int. Cl. G06F 9/455

(52) U.S. Cl. 703/25

(57) ABSTRACT

In at least some embodiments, a system comprises a first device having at least one manageable function and a second device coupled to the first device, the second device being capable of managing the at least one manageable function. The first device is configured to emulate a data endpoint recognized by the second device and the second device manages the at least one manageable function via the emulated data endpoint

### BACKGROUND

Connection of a local terminal device to a manageable device (e.g., a server, a “memory” storage cabinet or an uninterruptible power supply (“UPS”)) has been performed using dumb terminals (i.e., terminals without processing capability) and serial ports (e.g., RS-232 ports). Dumb terminals, however, are becoming increasingly obsolete due to the progression of laptop computers. Also, due to “legacy free” designs and physical space constraints on laptops, RS-232 ports are being removed.

Existing network ports (e.g., Ethernet ports) could provide a connection between a laptop and a manageable device. However, using network ports inconveniently requires changes to the network configuration of either or both of the laptop and the manageable device.

### BRIEF DESCRIPTION OF THE DRAWINGS

FIG. 1 illustrates a system in accordance with embodiments of the invention;

FIG. 2A illustrates a manageable device in accordance with embodiments of the invention;

FIG. 2B illustrates another manageable device in accordance with alternative embodiments of the invention;

FIG. 3 illustrates a rack of manageable devices in accordance with embodiments of the invention;

FIG. 4 illustrates a method in accordance with embodiments of the invention; and

FIG. 5 illustrates another method in accordance with alternative embodiments of the invention.

### NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more parts and may be used to refer to a computer system, a portion of a computer system, or a network of computer systems.

### DETAILED DESCRIPTION

As disclosed herein, embodiments of the invention permit connection of a local terminal device (e.g., a laptop) to a manageable device via a communication protocol such as the Universal Serial Bus (“USB”) protocol. In at least some embodiments, a processor of the manageable device emulates at least one data endpoint. As used herein, the term “data endpoint” refers to a starting point or a stopping point of data. In some embodiments, data endpoints refer to devices or device components that are assigned a unique identification number for use with a communication protocol.

By emulating a data endpoint compatible with the local terminal device, a communication interface is established between the local terminal device and the manageable device based on plug-and-play methods (i.e., configuration changes to the local terminal device are avoided). Using the established communication interface, the local terminal device is able to provide management functions for the manageable device. As used herein, a “management function” refers to a function associated with controlling, administrating, directing or evaluating resources and/or data of the manageable device. While USB-compatible devices are representative of some embodiments of the invention, other embodiments may implement other communication protocols now known or later developed.

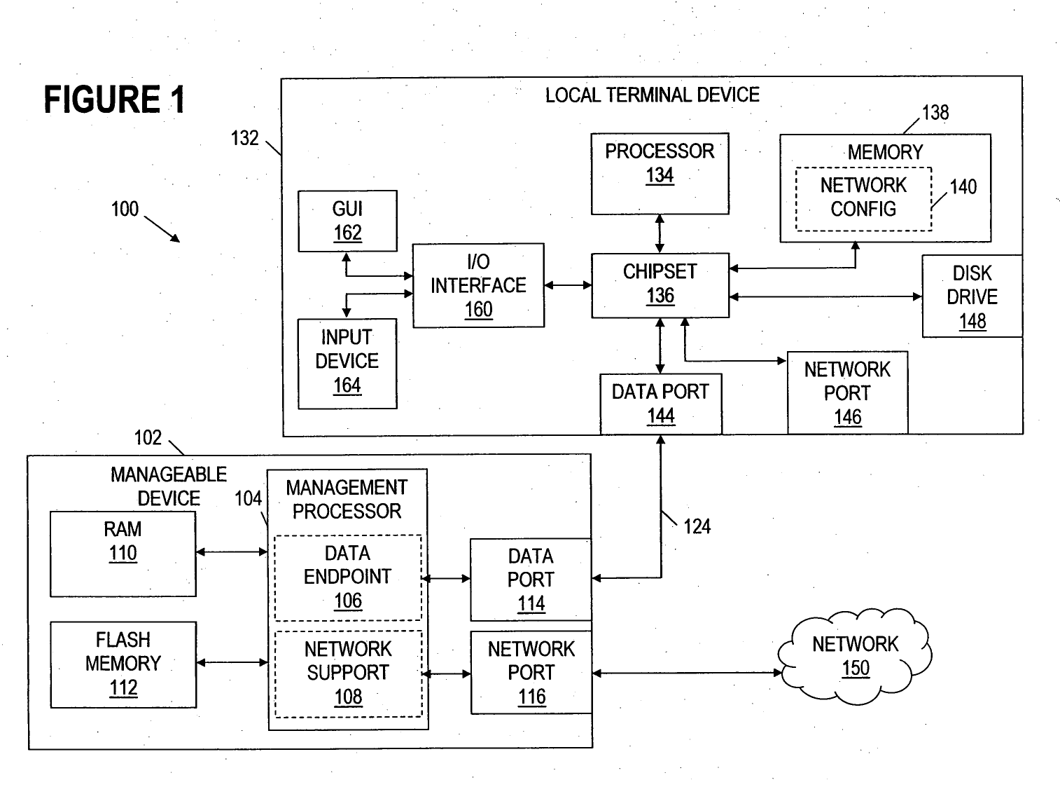

FIG. 1 shows a system 100 in accordance with embodiments of the invention. As shown in FIG. 1, the system 100 comprises a manageable device 102 coupled to a local terminal device 132. The local terminal device 132 may be, for example, a laptop computer and the manageable device 102 may be, for example, a server, a storage (i.e., memory) cabinet, an uninterruptible power supply (“UPS”) or another “headless” product (i.e., a product without a direct user interface).

The manageable device 102 comprises a management processor 104 configured to emulate a data endpoint 106 such as a USB endpoint (e.g., USB network adapter, a USB-to-Serial converter or a USB mass storage device). As shown, the data endpoint 106 couples to a data port 114, which, in some embodiments comprises a USB port. The management processor 104 further comprises network support logic 108 that couples to and provides network support to a network port 116 (e.g., an Ethernet port) of the manageable device 102. For example, in some embodiments, the network support logic 108 provides a network address whereby devices of a network 150 communicate with the manageable device 102. However, alternative embodiments of the manageable device 102 need not include the network port 116 nor the network support logic 108. The management processor 104 also couples to a random-access memory (“RAM”) 110 and a memory 112 (e.g., flash memory) which enable storage and access of instructions and/or data for use by the management processor 104.

As shown, a data cable 124 couples the data port 114 of the manageable device 102 to a corresponding data port 144 of the local terminal device 132 thereby permitting the manageable device 102 and the local terminal device 132 to communicate via a communication protocol. For example, in some embodiments, the data cable 124, the data port 114, the corresponding data port 144 and the communication protocol are USB-compatible. Additionally or alternatively, the manageable device 102 and the local terminal 132 may communicate based on a wireless method such as wireless USB or Bluetooth.

The local terminal device 132 also comprises a chipset 136 (e.g., a north bridge and a south bridge) that couples to and directs data between the data port 144, a processor 134 and a memory 138 which comprises, for example, a hard drive. The chipset 136 also couples to a network port 146 that enables communication to a network 150 and a disk drive 148 that reads/writes removable storage disks. In some embodiments, the disk drive 148 comprises a floppy disk drive or a compact disk (“CD”) drive.

As shown, the local terminal device 132 also comprises a graphic user interface (“GUI”) 162 and an input device 164 coupled to the chipset 136 via an input/output (“I/O”) interface 160. For example, the input device 164 may be a keyboard, a mouse, a touch pad or another device that enables a user to control functions of the local terminal device 132.

When the local terminal device 132 couples to the manageable device 102, the local terminal device 132 detects the data endpoint 106 emulated by the management processor 104. For example, the data endpoint 106 may present itself to the local terminal device 132 as a serial Universal Asynchronous Receiver Transmitter (“UART”) or a USB-to-Serial converter. Alternatively, the data endpoint 106 may present itself to the local terminal device 132 as a mass storage device such as a USB mass storage device. In still other embodiments, the management processor 104 is configured to emulate a network interface adapter (e.g., a USB Ethernet adapter) compatible with the local terminal device 132. For example, the data endpoint 106 may enable a Transmission Control Protocol/Internet Protocol (“TCP/IP”) interface and/or a Hyper Text Transfer Protocol (“HTTP”) interface such as HTTP/S. Emulation of a network interface would enable the manageable device 102 and the local terminal device 132 to establish a web-based interface without the limitations of a network protocol (e.g., existing network configurations of the manageable device 102 and the local terminal device do not need to be changed) and without installing specialized software on the local terminal device 132. For example, in some embodiments, an emulated data endpoint is recognizable using the default hardware and software (e.g., operating system drivers) of the local terminal device 132

In at least some embodiments, the management processor 104 is configured to emulate a plurality of data endpoints. For example, the USB protocol allows a single device such as the manageable device 102 to appear as a plurality of data endpoints. Thus, the management processor 104 may be configured to emulate at least one data endpoint that is compatible with local terminal devices (e.g., the local terminal device 102) now known or later developed. When the management processor 104 emulates at least one data endpoint that is compatible with the local terminal device 132, the local terminal device 132 recognizes the at least one data endpoint. Each data endpoint recognized by the local terminal device is capable of providing a communication interface and a management function between the manageable device 102 and the local terminal device 132.

In at least some embodiments, the management processor 104 is configured to emulate a data endpoint 106 that permits communication between the local terminal device 132 and the manageable device 102 without changing a configuration (e.g., a network configuration) of the local terminal device 132. Also, the network support logic 108 need not be affected by the emulated data endpoint 106. Thus, the manageable device 102 is able to communicate with the network 150 via the network port 116 as well as with the local terminal device 132 via the data port 114. Although the network 150 is able to provide some remote management functions, additional management functions that are not dependent on the network 150 are provided by the local terminal device 132.

The ability to communicate between the local terminal device 132 and the manageable device 102 without changing network configurations of the manageable device 102 and/or the local terminal device 132 provides several advantages. For example, if the manageable device 102 is a server, maintaining a network configuration (e.g., maintaining a fixed network address) enables devices of the network 150 to access information provided by the server without delays. Thus, while a communication interface may be established between the manageable device 102 and the local terminal device 132 based on the network support logic 108 and the network port 116 (or another port), such a communication interface interferes with the manageable device's ability to communicate with the network 150. Also, the network support logic 108 does not necessarily permit the same management functions that are provided via the data endpoints emulated by the management processor 104.

Similarly, changing a network configuration 140 of the local terminal device 132 for use with the network support logic 108 of the manageable device 102 may cause the local terminal device 132 to be temporarily unsuited for use with available networks (e.g., the network 150) or network-based devices. Thus, not requiring a change of configuration reduces the time and expertise needed to use the local terminal device 132 with the manageable device 102. For example, in some embodiments, the emulated data endpoint 106 and the data port 114 enable plug-and-play methods between the manageable device 102 and the local terminal device 132.

Additionally or alternatively, in at least some embodiments, the management processor 104 is configured to emulate a data endpoint 106 that permits communication between the local terminal device 132 and the manageable device 102 without installing specialized hardware/software on the local terminal device 132 (i.e., communication is based on a local terminal device's default hardware/software configuration). In such embodiments, the parameters of local terminal devices (now known of later developed) such as available communication protocols, hardware, software or other parameters are considered to determine the at least one compatible data endpoint 106 to be emulated by the management processor 104. The ability to communicate between the local terminal device 132 and the manageable device 102 without adding specialized hardware/software to the local terminal device 132 provides several advantages.

For example, the manageable device 102 may be implemented in an environment in which different local terminals devices are connected to the manageable device 102 at different times. Thus, not requiring specialized hardware/software avoids the difficulty associated with locating and installing the hardware/software for each of the different local terminal devices. Also, not requiring specialized hardware/software avoids the difficulty associated with preparing the hardware/software for different computer architectures and/or operating systems that may be implemented by the different local terminal devices.

In some embodiments, multiple levels of communication interfaces are provided between the local terminal device 132 and the manageable device 102. Each level of interfaces may selectively employ at least one communication method. Also, each level of interfaces as well as each communication method may be associated with a different set of management functions. As described herein, first level interfaces comprise interfaces that are available between the local terminal device 132 and the manageable device 102 based on data endpoint emulation without installing specialized hardware/software or changing network configurations of the local terminal device 132 or the manageable device 102.

For example, in some embodiments, the first level interfaces include a command line interface (available by emulating a compatible hardware interface), a file transfer interface (available by emulating a compatible mass storage device) and a web-based interface such as a “browser” (available by emulating a compatible network adapter). These first level interfaces enable management functions related to, for example, the command line interface, file transfers or web-based management.

The second level interfaces comprise interfaces that are available between the local terminal device 132 and the manageable device 102 by installing specialized software (e.g., software drivers) on the local terminal device 132. In such embodiments, the software to be installed is provided to the local terminal device 132 from the manageable device 102 via an established first level interface. The second level interfaces provide at least one additional management function to the management functions provided by the first level interfaces. For example, the additional management function may be more advanced than the management functions provided by the first level interfaces. In some embodiments, management functions provided by the second level interface are based on the particular capabilities of the management processor 104 (besides data endpoint emulation). For example, some management processors provide a graphical remote console or specialized testing capabilities.

After a first level interface has been established between the manageable device 102 and the local terminal device 132, the local terminal device 132 performs the available management functions for manageable device 102 via the data endpoint 106. For example, in some embodiments, the local terminal device 132 is configured to provide a command line interface in response to connecting to a Serial Bus port or virtual Serial Bus port. In such embodiments, the data endpoint 106 emulated by the management processor 104 may be a USB-to-Serial port converter such that the local terminal device 132 is able to connect to the manageable device 102 via a USB cable and USB ports, but reacts as if connected to a Serial port (by providing the command line interface). The command line interface enables a user to perform management functions such as querying for information, analyzing data or issuing a command to the manageable device 102.

As previously described, the data endpoint 106 may appear to a local terminal device 132 as a serial UART. In at least some embodiments, the serial UART appears to the local terminal device 132 at one or more prescribed addresses expected by the local terminal device 132 for serial communication. For example, in the IBM-PC/x86 architecture, the one or more prescribed addresses correspond to “COM” ports. Thus, the emulated Serial UART appears to be connected to the local terminal device's COM port even though the data port 144 is not a COM port. After the command line interface is established, a user of the local terminal device may issue compatible commands (e.g., using the GUI 162 and the input device 164) to the manageable device 102 via the command line interface.

In some embodiments, the data endpoint 106 interfaces with a terminal emulation program (e.g., HyperTerminal) executed by the local terminal device 132 which permits commands to be issued to the manageable device 102 from the local terminal device 102. Additionally or alternatively, a user may implement the terminal emulation program executed by the local terminal device 132 to view status information of the manageable device 102 using the data endpoint 106 for input and output.

In some embodiments, the local terminal device 132 is configured to upload/download data files from a mass storage device. In such embodiments, the data endpoint 106 emulated by the management processor 104 comprises a mass storage device such as a USB mass storage device. By emulating a mass storage device, the management processor 104 enables data files such as Hypertext Markup Language (“HTML”) web pages, text files, executable management files or other files to be transferred between the manageable device 102 and the local terminal device 132. Thus, a user is able to transfer firmware updates or configuration files to the manageable device 102 as if the manageable device 102 were simply a mass storage device. In reality, the firmware updates or the configuration files are stored in the RAM 110 and/or the memory 112 of the manageable device 102 and are used by the manageable device 102 to control one or more functions.

In still other embodiments, the local terminal device 132 is configured to access (e.g., browse) data files and transfer data files via a network connection. In such embodiments, the data endpoint 106 emulated by the management processor 104 comprises a network adapter such as a USB Ethernet network adapter. By emulating a network adapter, the management processor 104 enables the local terminal device 132 to access files on the manageable device 102 or to transfer files to the manageable device 102 using a network protocol such as TCP/IP or HTTP/S. Thus, a user is able to transfer firmware updates or configuration files to the manageable device 102 as if the manageable device 102 were simply a network device compatible with the local terminal device 132. In reality, the firmware updates or the configuration files are stored in the RAM 110 and/or the memory 112 of the manageable device 102 and are used by the manageable device 102 to control one or more management functions.

As previously mentioned, emulating a network adapter enables network-based functions between the manageable device 102 and the local terminal device 132 without disturbing network communications between the manageable device 102 and the network 150. For example, if the manageable device 102 is a server, disturbing or changing existing network configurations (provided by the network support logic 108) will prevent devices of the network 150 from locating the server and accessing data and services provided by the server.

In some embodiments, the local terminal device 132 is configured to recognize peripheral devices based on plug-and-play methods. In such embodiments, the data endpoint 106 emulated by the management processor 104 comprises a plug-and-play device compatible with the local terminal device 132. For example, by emulating a plug-and-play compatible mass storage device with executable files (e.g., software drivers and other install.exe files), the management processor 104 enables the executable files to be transferred from the manageable device 102 to the local terminal device 132. In some embodiments, the executable files are pre-stored in the memory 112 of the manageable device 102.

Once a first level interface has been established between the local terminal device 132 and the manageable device 102, the local terminal device 132 is able to upload the executable filesvia the first level interface. For example, if the executable file is an install.exe file, the local terminal device 132 is able to upload the install.exe file and install, for example, a software driver. In at least some embodiments, the software driver enables the local terminal device 132 to recognize the manageable device 102 and/or to perform management functions based on at least one second level interface provided by the software driver. In such embodiments, the first level interfaces and corresponding management functions are still available for use by the local terminal device 132 after the at least one second level interface is established.

In some embodiments, the software driver enables a management interface between the local terminal device 132 and the manageable device 102 that is particular to the capabilities of the management processor 104. For example, a given manageable device may implement a management processor 104 (e.g., the Integrated Lights Out “iLo” processor) configured to provide a graphical remote console. In such case, the given manageable device may present itself as a mass storage device recognized by the local terminal device 132 without installing software or changing network configurations on the local terminal device 132 (i.e., a first level interface is established) or the manageable device 102. Thereafter, the local terminal device 132 downloads software via the first level interface and installs the software. The software provides a second level interface that permits the local terminal device 132 to interface with the graphical remote console provided by the management processor 104.

In alternative embodiments, a given manageable device (e.g., a diagnostic module) implements a management processor 104 that can provide an interface for certain tests such as Test Access Point tests and Boundary Scan tests (also known as “JTAG” tests). In such embodiments, the given manageable device presents itself as a mass storage device recognized by the local terminal device 132 without installation of hardware/software or changing a configuration on the local terminal device 132 (i.e., a first level interface is established). Thereafter, the local terminal device 132 downloads the software via the first level interface and installs the software. The software provides a second level interface that enables the local terminal device 132 to execute the tests on the interface provided by the management processor 104.

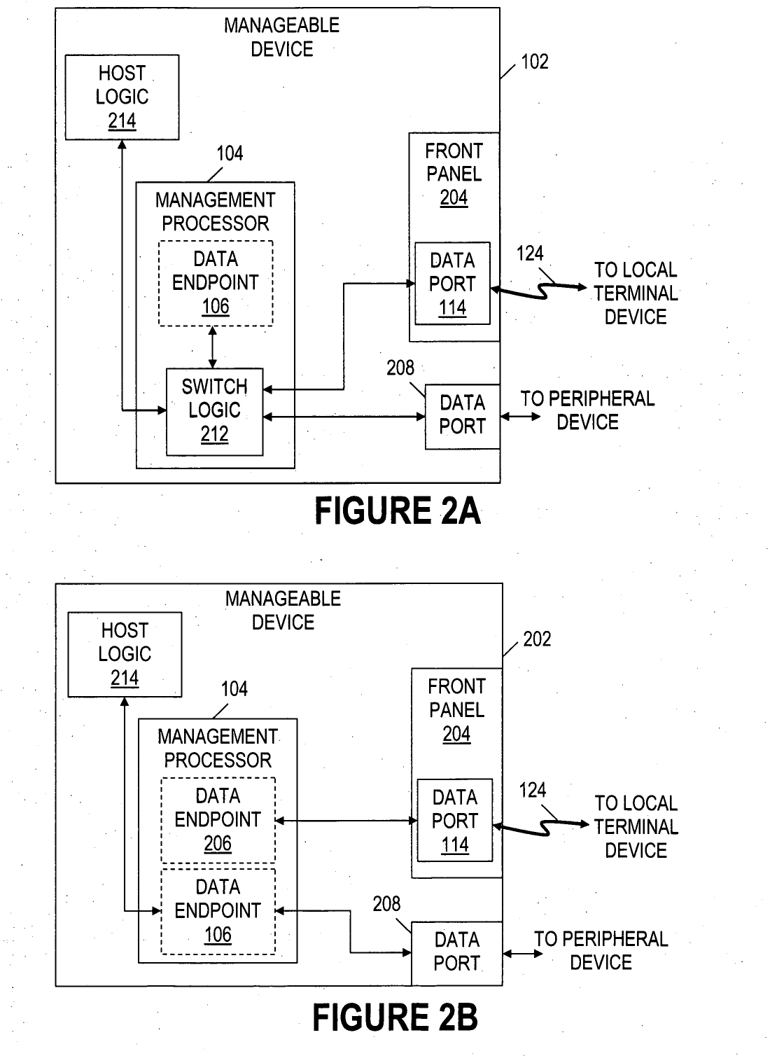

FIG. 2A illustrates a simplified block diagram of a manageable device 102 in accordance with embodiments of the invention. Thus, the manageable device 102 of FIG. 2A may comprise other components such as those shown previously in FIG. 1. As shown in FIG. 2A, the manageable device 102 comprises a management processor 104 that emulates at least one data endpoint 106. The management processor 104 also has switch logic 212 that couples to a data port 114 and to a data port 208. The manageable device 102 further comprises host logic 214 coupled to the switch logic 212. The host logic 214 enables the manageable device 102 to act as a host to peripheral devices coupled to the data port 208. For example, in embodiments in which the peripheral devices comprise USB-based devices (e.g., a keyboard, a mouse, a floppy disk drive or a CD-ROM drive), the host logic 214 may comprise USB host controller logic. Thus, when a peripheral device couples to the data port 208, the management processor 104 enables the host logic 214 and the peripheral device coupled to data port 208 to communicate.

In at least some embodiments, the switch logic 212 enables either a peripheral device to communicate with the host logic 214 (via the data port 208) or enables a local terminal device to communicate with the emulated data endpoint 106 (via the data port 114). If a peripheral device couples to the data port 208 and a local terminal device couples to the data port 114 at the same time, the switch logic 212 implements a prioritization scheme. For example, in some embodiments, the switch logic 212 gives priority to communication between a local terminal device and the emulated data endpoint 106. Additionally or alternatively, the switch logic 212 is configurable by a user. Therefore, the manageable device 202 may act as a host device to peripheral devices coupled thereto and act as a peripheral device to a local terminal device.

As shown, the data port 114 is part of a front panel 204 and is used to couple a local terminal device to the manageable device 102 via a data cable 124. Alternatively, the data port 114 may enable wireless communication (e.g., wireless USB or Bluetooth) between the manageable device 102 and a local terminal device.

When a local terminal device is coupled to the data port 114, the switch logic 212 may discontinue and/or prevent communication between a peripheral device and the host logic 214. In such case, the switch logic 212 connects the local terminal device to the emulated data endpoint 106 such that the manageable device 102 becomes a “target” and the local terminal device acts as the manageable device's host. In some embodiments, a particular port (e.g., the data part 114) of the manageable device 102 may be assigned for use with local terminal devices and may be located to facilitate connection to local terminal devices. For example, the data port 114 is shown as part of the manageable device's front panel 204, thus providing a straightforward connection between a local terminal device and the manageable device 102.

FIG. 2B illustrates a simplified block diagram of another manageable device 202 in accordance with alternative embodiments of the invention. Thus, the manageable device 202 may comprise other components such as those components illustrated for the manageable device 102 of FIG. 1. As shown in FIG. 2B, the manageable device 202 comprises host logic 214 coupled to a management processor 104 that emulates multiple data endpoints, including a first data endpoint 106 and a second data endpoint 206. The first data endpoint 106 couples to the data port 208 and provides a dedicated connection between the host logic 214 and peripheral devices coupled to the data port 208. The second data endpoint 206 couples to the data port 114 and provides a dedicated connection for local terminal devices. Thus, peripheral devices and a local terminal device are supported simultaneously. Also, in some embodiments, the manageable device 202 is part of a network and supports network communications in addition to communications with a local terminal device. As shown, the data port 114 is located on a front panel 204 of the manageable device 202, thus providing a port that is easily accessible to a local terminal device's user.

In at least some embodiments, the emulated second data endpoint 206 provides a first level interface (i.e., an interface available by emulating a data endpoint recognized by local terminal devices without changing configurations or installing hardware/software on a local terminal device) compatible with a local terminal device. Additionally, the second data endpoint may provide a second level interface for a local terminal device after the local terminal device has uploaded specialized software via an established first level interface and installed the specialized software. The second data endpoint 206 may appear, for example, as diagnostic equipment (sometimes referred to as a “crash cart”) on local terminal devices. Alternatively, the second data endpoint 206 may appear as a new device to local terminal devices. In either case, second data endpoint 206 may enable features such as a real-time virtual compact disk (“CD”) device, a real-time virtual floppy disk device, a remote graphical console output, a testing interface or another programmatic interface (e.g., an Extensible Markup Language (“XML”) interface).

Using the second data endpoint 206, local terminal devices provides a user with benefits such as graphical console access, text console access, configuration of in-band and out-of-band management and access to logs and diagnostics of the manageable device 202. The second data endpoint 206 also may enable the manageable device 202 to read/write to a disk drive (e.g., the disk drive 148 shown in FIG. 1) of a local terminal device and to transfer files to and from a local terminal device's memory (e.g., the memory 138 shown in FIG. 1).

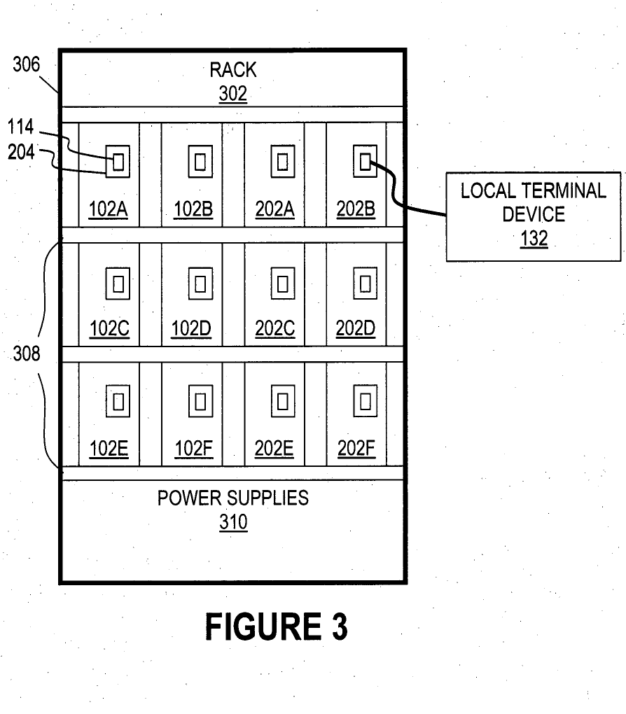

FIG. 3 illustrates a rack 302 of manageable devices in accordance with embodiments of the invention. As shown in FIG. 3, the rack 302 comprises an enclosure 306 that houses a plurality of manageable devices 102A-102F, 202A-202F on shelves 308. Each manageable device 102A-102F, 202A-202F comprises a front panel 204 having a port 114 so that a local terminal device 132 is able to easily connect thereto via an appropriate data cable. Alternatively, the each manageable device 102A-102F, 202A-202F may communicate to the local terminal device 132 using a wireless method. In at least some embodiments, the port 114 comprises a USB port. As shown, the rack 302 also comprises power supplies 310 that provide power to the manageable devices 102A-102F, 202A-202F.

As described previously in FIGS. 1, 2A and 2B, each manageable device 102A-102F, 202A-202F is configured to emulate at least one data endpoint or device recognized by the local terminal device 132. By emulating a recognizable data endpoint, a communication interface is automatically established between the local terminal device 132 and the manageable device coupled thereto (e.g., the manageable device 202B). The emulation enables the a communication interface to be established between the local terminal device 132 and the manageable device coupled thereto without needing to install hardware/software or change configurations on the local terminal device 102. In particular, changing network configurations is avoided.

In some embodiments, specialized software is provided to the local terminal device 132 from the manageable device 202B coupled thereto via the established communication interface. By executing the specialized software, the local terminal device 132 is able to establish an improved communication interface that is particularized to the manageable device 202B coupled thereto. For example, the improved communication interface may take advantage of certain capabilities (e.g., a remote graphical console or testing interface) particular to the manageable device 202B.

The capabilities of the manageable device 202B may be different from the other manageable devices 102A-102F, 202A, 202C-202F. Thus, all the manageable devices 102A-102F, 202A-202F are configured to establish a first level interface with the local terminal device 132 that does not require installing hardware/software or changing configurations on the local terminal device 102. The first level interfaces may enable the local terminal device 132 to access text, a serial OS console or a BIOS setup of the manageable devices 102A-102F, 202A-202F. The first level interface also may enable the manageable devices 102A-102F, 202A-202F to use resources (e.g., hard drives, removable disk drives, compatible programs) provided by the local terminal device 132.

Additionally, at least some of the manageable devices (e.g., devices 202A-202F) are configured to establish a second level interface by providing specialized software to local terminal device 132 via the first level interface. As described previously, the specialized software may be particularized to each manageable device 202A-202F and may be based on the capabilities of each manageable device 202A-202F.

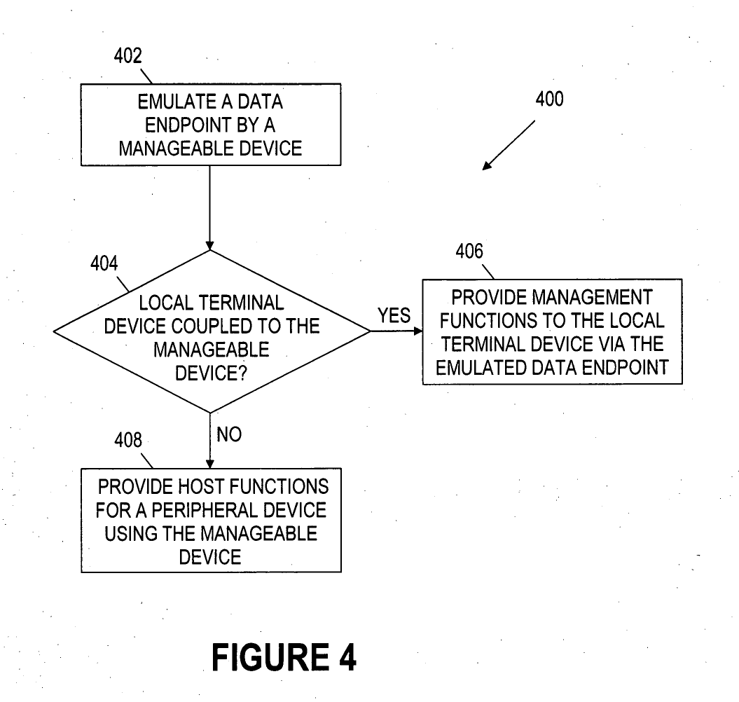

FIG. 4 illustrates a method 400 in accordance with embodiments of the invention. As shown in FIG. 4, the method 400 comprises emulating a data endpoint or device by a manageable device (block 402). For example, the. emulated data endpoint may be a particular hardware interface, a network adapter or a mass storage device and the manageable device may be a headless device. If a determination is made that a local terminal device is coupled to the manageable device (determination block 404), management functions (for controlling the manageable device) are provided to the local terminal device via the emulated data endpoint (block 406). If a determination is made that a local terminal device is not coupled to the manageable device (determination block 404), host functions for a peripheral device are provided using the manageable device (block 408). For example, in some embodiments, the host functions enable a manageable device to host a peripheral device such as a keyboard, a mouse, a floppy disk drive or a CD drive.

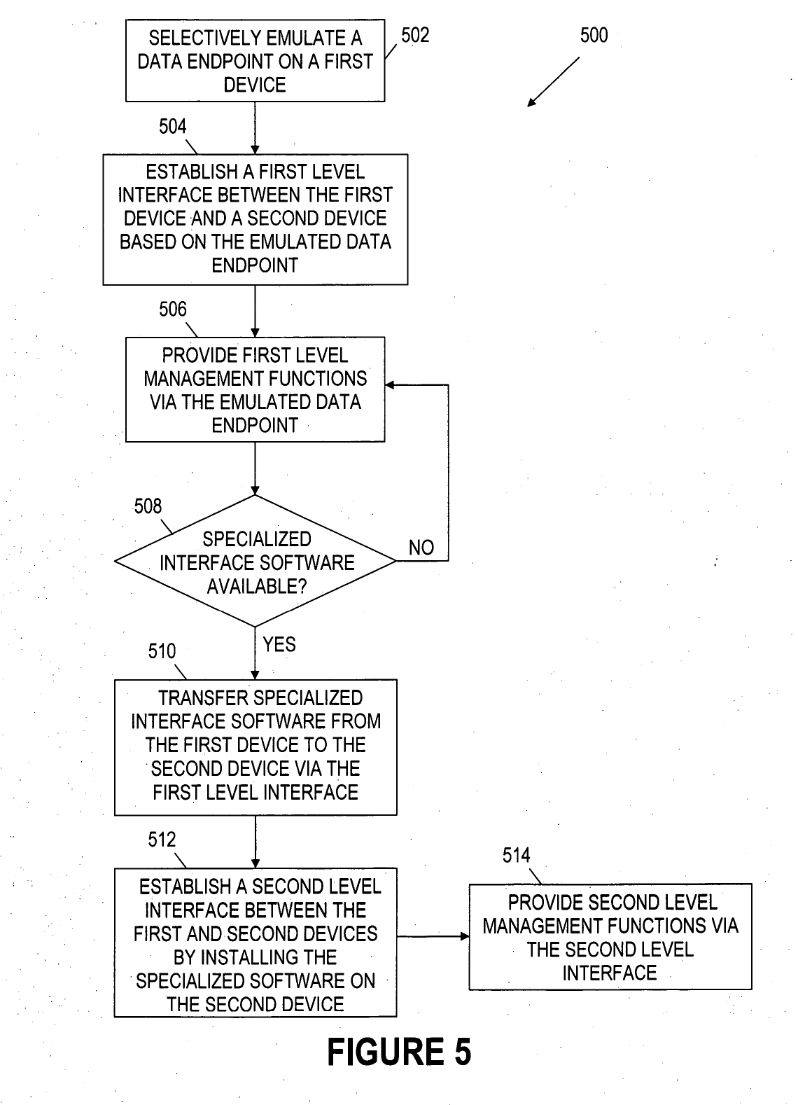

FIG. 5 illustrates another method 500 in accordance with alternative embodiments of the invention. As shown, the method 500 comprises selectively emulating a data endpoint on a first device (block 502). Thus, first device selects one of multiple data endpoints to emulate. In some embodiments, the data endpoint is selected based on compatibility with a second device. The method 500 further comprises establishing a first level interface between the first device and a second device based on the emulated data endpoint (block 504). In at least some embodiments, establishing a first level interface does not involve installing hardware/software or changing configurations on the second device. At block 506, first level management functions are provided via the emulated data endpoint. The first level management functions enable the second device to manage the first device and may comprise any management functions available via the first level interface.

If a determination is made that specialized interface software is not available (determination block 508), the method 500 continues to provide the first level management functions (block 506). If a determination is made that specialized interface software is available (determination block 508), the specialized interface software is transferred from the first device to the second device via the first level interface (block 510). In some embodiments, available specialized software need not be transferred. For example, a user may choose not to transfer the specialized software or the specialized software may have been previously transferred. At block 512, a second level interface is established between the first and second devices by installing the specialized interface software on the second device. The method 500 proceeds by providing second level management functions via the second level interface (block 514). For example, the second level management functions may be associated with particular capabilities of the first device (e.g., remote graphic console or testing capabilities). In some embodiments, both the first level management functions and the second level management functions are available after the second level interface is established.

The above discussion is meant to be illustrative of the principles and various embodiments of the present invention. Numerous variations and modifications will become apparent to those skilled in the art once the above disclosure is fully appreciated. For example, after an initial interface is established, manageable devices that have multiple specialized capabilities may selectively provide software to a local terminal device to enable the local terminal device to manage each specialized capability individually or in combination with each other. It is intended that the following claims be interpreted to embrace all such variations and modifications.

What is claimed is:

1. A system, comprising:
a first device having at least one manageable function; and
a second device coupled to the first device, the second device being capable of managing the at least one manageable function,
wherein the first device is configured to emulate a data endpoint recognized by the second device and wherein the second device manages the at least one manageable function via the emulated data endpoint.

2. The system of claim 1 wherein the emulated data endpoint is recognized by the second device using default software and hardware of the second device.

3. The system of claim 1 wherein the emulated data endpoint is recognized by the second device without changing a network configuration of the second device.

4. The system of claim 1 wherein the emulated data endpoint comprises a network adapter.

5. The system of claim 1 wherein the emulated data endpoint comprises a mass storage device.

6. The system of claim 1 wherein the emulated data endpoint comprises a Serial Universal Asynchronous Receiver Transmitter (“UART”).

7. A manageable device, comprising:
a processor configured to emulate a data endpoint; and
a first data port coupled to the processor,
wherein, if an external device couples to the first data port, the emulated data endpoint enables the external device to automatically establish a communication interface with the manageable device via the emulated data endpoint,
wherein the communication interface enables the external device to perform management functions for the manageable device.

8. The manageable device of claim 7 wherein the processor is configured to simultaneously emulate a plurality of data endpoints, wherein each data endpoint enables different management functions.

9. The manageable device of claim 7 further comprising host logic coupled to the processor, the host logic enables the manageable device to act as a host to a peripheral device.

10. The manageable device of claim 9 wherein the processor comprises switch logic and wherein the switch logic selectively enables communication between the external device and the emulated data endpoint and between a peripheral device and the host logic.

11. The manageable device of claim 10 wherein the switch logic gives highest priority to communication between the predetermined external device and the emulated data endpoint.

12. The manageable device of claim 7 wherein the processor simultaneously emulates at least a first data endpoint and a second data endpoint and wherein the first data endpoint enables the external device to automatically establish a communication interface with the manageable device and the second data endpoint enables the manageable device to act as a host for peripheral devices.

13. The manageable device of claim 7 further comprising a memory coupled to the processor,. wherein the memory stores software that is transferable to the external device via the emulated data endpoint after establishment of the communication interface and wherein installation of the software by the external device enables the external device to perform additional management functions for the manageable device.

14. A method, comprising:
emulating a Universal Serial Bus (“USB”) data endpoint on a first device;
establishing a first communication interface between the first device and a second device via the emulated USB data endpoint;
providing management functions for the first device, the management functions are performed by the second device via the first communication interface.

15. The method of claim 14 further comprising transferring specialized interface software from the first device to the second device via the first communication interface.

16. The method of claim 15 further comprising establishing a second communication interface between the first device and the second device by installing the specialized interface software on the second device, wherein the second communication interface provides at least one additional management function.

17. A system, comprising:
a terminal device having a default hardware and software configuration;
and
a manageable device configured to establish a communication interface with the terminal device by emulating a data endpoint compatible with the terminal device's default hardware and software configuration,
wherein the terminal device provides a management function for the manageable device via the established communication interface.

18. The system of claim 17 wherein the data endpoint is selected from a group of Universal Serial Bus (“USB”) compatible data endpoints consisting of a network adapter, a mass storage device, and a Serial Universal Asynchronous Receiver Transmitter.

19. The system of claim 17 further comprising a network coupled to the manageable device, wherein the established communication interface does not interfere with network communications between the network and the manageable device.

20. The system of claim 17 further comprising a peripheral device coupled to the manageable device, wherein the manageable device acts as a host to the peripheral device and acts as a peripheral device to the terminal device.
